(19) United States
(12) Patent Application Publication
(10) Pub. No.: US 2026/0313006 A1
(43) Pub. Date: Oct. 8, 2026

(54) SYSTEMS AND METHODS FOR TRIGGERING DATA CHANNEL SETUP IN USER EQUIPMENT USING OPERATIONS, ADMINISTRATION, AND MAINTENANCE DEVICE MANAGEMENT

(71) Applicant: Nokia Technologies Oy, Espoo (FI)

(72) Inventors: Rainer LIEBHART, Munich (DE); Peter LEIS, Munich (DE)

(21) Appl. No.: 19/482,686

(22) PCT Filed: Mar. 1, 2024
(86) PCT No.: PCT/EP2024/055426

§ 371 Date: Nov. 7, 2025

Related U.S. Application Data
(60) Provisional application No. 63/501,989, filed on May 12, 2023.

(51) Int. Cl. H04L 65/1016; H04L 65/1069; H04W 40/24

(52) U.S. Cl. CPC H04L 65/1016; H04L 65/1069; H04W 40/246

(57) ABSTRACT

A method, apparatus and computer program product are provided for triggering and performing data channel setup in user equipment. In the context of a method, the method includes obtaining a data object indicative of internet protocol multimedia subsystem (IMS) data channel (DC) configuration data, the IMS DC configuration data comprising information regarding whether a user equipment (UE) is allowed to establish an IMS data channel. The method also includes generating an IMS DC establishment decision based at least in part on the data object. The method also includes performing an action based at least in part on the IMS DC establishment decision.

### TECHNICAL FIELD

An example embodiment relates generally to techniques for triggering and performing data channel setup in user equipment.

### BACKGROUND

In legacy communication systems, initiation of data channel (DC) setup is left to individual user equipment (UE)-specific implementations. Such approaches may result in undesirable consequences such as waste of resources due to instances where all UEs of a public land mobile network (PLMN) that use internet protocol multimedia subsystem (IMS) multimedia telephony service (MMTel) always setup a bootstrap data channel in parallel to an associated MMTel audio/video session. Further, such instances may lead to unpredictable use of the DC(s) that is not under control of operators.

### BRIEF SUMMARY

A method, apparatus and computer program product are provided in accordance with an example embodiment to use operations, administration, and maintenance device management (OAM DM) to trigger data channel (DC) setup in user equipment (UE). In various embodiments, the present method, apparatus, and computer program product provide improved solutions for triggering DC channel setup in UE, which overcomes challenges of legacy DC approaches where DC setup is relegated to UE-specific implementations. For example, in roaming cases or particular devices or device types, an operator may desire to disable or enable DC usage. As another example, an operator may desire to guide the UE to use only one bootstrap DC during an internet protocol multimedia subsystem (IMS) registration lifetime or once during an IMS MMTel session lifetime. In various embodiments, the DC channel setup-triggering solutions of the present disclosure enable such functionalities, which are not available or achievable in previous approaches. For example, the present method, apparatus, and computer program product may allow a home public land mobile network (HPLMN) operator to configure UEs as to when the UEs set setup a DC for bootstrap. As another example, the present method, apparatus, and computer program product may allow a HPLMN operator to control whether and how the UE performs (DC) setup during an IMS session, which may allow operators to disable DC for certain UEs or in roaming use cases and force the UE to use only one bootstrap DC for downloading applications during the IMS registration timeline.

In various embodiments, the described DC setup-triggering solution allows the HPLMN to control UE behavior as to whether and when the UE shall setup a data channel (DC). For example, the present method, apparatus, and computer program product may trigger setup of bootstrap DCs that are used to download a user specific application list and individual applications (e.g., HTML pages). In one or more embodiments, the present method, apparatus, and computer program product provide a mechanism for triggering DC channel setup, which may be referred to as an IMS data channel handling policy. In some embodiments, the method, apparatus, and computer program product use OMA Device Management (OMA DM) to configure parameters and/or behaviors in the UE including (i) the UE shall not establish an IMS DC, (ii) UE to establish an IMS DC when a MMTel session associated with the UE is established, (iii) UE to establish an IMS DC only when in the HPLMN, and (iv) UE to establish an IMS DC only once during the IMS registration lifetime or during the MMTel session lifetime. In some embodiments, OMA DM is a suite of protocols running over the user plane. In some embodiments, the method, apparatus, and computer program product configure one or more of the previously listed parameters and/or behaviors in a universal integrated circuit card (UICC). In some embodiments, alternatively or in addition to using OMA DM, the method, apparatus, and computer program product use other protocols or means to configure the parameters and/or behaviors in the UE or on the UICC (e.g., and potentially other DC related information, such as a universal resource locator (URL) at which a list of available DC applications and associated parameters may be downloaded). For example, the other protocols or means may include non-access stratum (NAS) control plane signaling, short message service (SMS) service, and/or user equipment route selection policy (URSP) rules.

In some embodiments, in instances where (i) a UE sets up an IMS MMTel session, (ii) the UE supports DCs, and (iii) the UE is configured with IMS data channel handling policy configured (e.g., via OMA DM), the present method, apparatus, or computer program product cause the UE to perform one or more condition-based operations. In some embodiments, in a first conditional instance, the method, apparatus, or computer program product determine if the IMS DC handling policy indicates to not open an IMS DC. In some embodiments, in response to determining the IMS DC handling policy indicates to not open an IMS DC, the method, apparatus, or computer program product prevent the UE from opening a DC (e.g., or otherwise configure the UE not to open an IMS DC).

In some embodiments, in a second conditional instance, the method, apparatus, or computer program product determine if the IMS DC handling policy indicates to open the IMS DC when an MMTel session associated with the UE is established (e.g., and if the network has indicated IMS DC support during the IMS registration procedure). In some embodiments, in response to determining the IMS DC handling policy indicates to open the IMS DC when the IMS MMTel Session is already established (e.g., and that the network has indicated IMS DC support during the IMS registration procedure), the method, apparatus, or computer program product cause the UE to open the IMS DC in parallel to the IMS MMTel session.

In some embodiments, in a third conditional instance, the method, apparatus, or computer program product determine if the IMS DC handling policy indicates to open the IMS DC when in HPLMN. In some embodiments, in response to determining the IMS DC handling policy indicates to open the IMS DC when in HPLMN, the method, apparatus, or computer program product cause the UE to open the IMS DC only when registered in the home network.

In some embodiments, in a fourth conditional instance, the method, apparatus, or computer program product determine if the IMS DC handling policy indicates to open the IMS DC only once during the IMS registration lifetime or during the MMTel session lifetime. In some embodiments, in response to determining the IMS DC handling policy indicates to open the IMS DC only once during the IMS registration lifetime or during the MMTel session lifetime, the method, apparatus, or computer program product cause the UE to open the IMS DC only once after the initial IMS registration or once after the MMTel session associated with the UE is established. In some embodiments, in a fifth conditional instance, in response to determining that the UE is not configured with an IMS data channel handling policy, the method, apparatus, or computer program product cause the UE to perform IMS data channel setup based on the UE implementation. In some embodiments, the method, apparatus, or computer program product cause the UE to an IMS DC session only during or after multimedia session establishment. In some embodiments, the apparatus, method, or computer program product provide an IMS DC establishment solution where a UE can be configured by the HPLMN via DM or in the UICC to control when the UE may initiate a DC establishment request. In various embodiments, this solution allows the HPLMN to (i) control whether and when a UE will setup a DC connection, and (ii) align the behavior between multiple UEs.

In some embodiments, the method, apparatus, or computer program product trigger a UE to establish an IMS Data Channel simultaneously while establishing an IMS audio/video session or upgrade an ongoing IMS audio/video session through a re-INVITE to an IMS Data Channel session. In some embodiments, the method, apparatus, or computer program product determine that a UE that has not subscribed to IMS DC attempts to establish an IMS DC simultaneously with an IMS MMTel session. In some embodiments, in response to the determining, the method, apparatus, or computer program product cause the IMS Application Server (IMS AS) to discard the DC request of the UE and proceed with the IMS MMTel session establishment. In some embodiments, the method, apparatus, or computer program product, cause a data channel signaling function (DCSF) to provide a URL to the data channel media function (DCMF) or multimedia resource function (MRF) via the IMS AS during data channel media resource reservation for the bootstrap data channel that enables downloading a subscriber specific graphical user interface to the UE via the Bootstrap Data Channel. In some embodiments, once the DCMF or MRF, acting as HTTP proxy, receive a HTTP GET Request containing the root (“/”) URL through the bootstrap data channel, the method, apparatus, or computer program product cause the DCMF or MRF to replace the root (“/”) URL in the HTTP GET Request with the subscriber specific URL and forward the request to the DCSF for downloading the subscriber specific graphical user interface to the UE. In some embodiments, the method, apparatus, or computer program product cause the UE to maintain the HTTP session state when interacting with the DCMF.

In some embodiments, information for the binding of a DC application with the related DC is required to support multiple, simultaneous DC applications in a UE. In some embodiments, the binding information is allocated by the HPLMN or retrieved from DC application provider when the DC application is uploaded to DCSF. In some embodiments, the method, apparatus, or computer program product configure the DCSF with a DC application profile associated with the binding information, which indicates the DC control policy (e.g., whether the application DC establishment follows the P2P or P2A/A2P procedure). In some embodiments, the UE receives the binding information of a DC application via the Bootstrap DC (e.g., when the DC application is downloaded to the UE). In some embodiments, when the UE is establishing an IMS Application DC, the binding information is provided by the UE in the SDP offer. In some embodiments, the IMS AS provides the binding information to the DCSF. In some embodiments, the DCSF may use the binding information for controlling the application DC setup. In various embodiments, the present method, apparatus, or computer program product embody or include the DCSF.

In some embodiments, OMA DM is based on a client/server architecture where the DM client is implemented on the UE. In some embodiments, an OMA DM server is in the operator core network. In some embodiments, XML structures, referred to as Management Objects (MO), are used for data exchange. In some embodiments, OMA DM supports one or more data transport protocols such as hypertext transfer protocol (HTTP). In some embodiments, the communication protocol is a request/response protocol that provides authentication of the involved parties. In some embodiments, the communication is initiated by the OMA DM server via SMS. In some embodiments, the initial message from the DM server to the DM client (e.g., user equipment) is a notification message. Additionally, or alternatively, in some embodiments, the DM client queries the DM server by its own. In some embodiments, a first step of the provisioning phase is referred to as “bootstrapping.” In some embodiments, bootstrapping is required between the DM client and the DM server to establish a secure path between the two entities for initiating the management session. In some embodiments, upon successful execution of the bootstrapping process, a secure path between DM client and DM server is established and additional steps of the provisioning process are initiated. In some embodiments, during the management session, the provisioning of the DM client with all relevant data takes occurs. In some embodiments, a sequence of messages is exchanged between the DM client and the DM server to complete one or more DM tasks.

In at least one embodiment, a method is provided that includes (i) obtaining a data object indicative of internet protocol multimedia subsystem (IMS) data channel (DC) configuration data, the IMS DC configuration data comprising information regarding whether a user equipment (UE) is allowed to establish an IMS data channel, (ii), generating an IMS DC establishment decision based at least in part on the data object, and (iii) performing an action based at least in part on the IMS DC establishment decision. In some embodiments, obtaining the data object includes receiving the data object from an operations, administration, and maintenance management device. In some embodiments obtaining the data object includes generating the data object based at least in part on universal integrated circuit card (UICC) configuration data. In various embodiments, as used herein, universal integrated circuit card (UICC) configuration data includes configuration data of a UICC.

In some embodiments, obtaining the data object includes obtaining the data object via non-access stratum (NAS) control plane signaling. In some embodiments, obtaining the data object includes obtaining the data object via a short messaging service (SMS) service. In some embodiments, obtaining the data object, includes generating the data object based at least in part on one or more user equipment route selection policy (URSP) rules. In various embodiments, as used herein, internet protocol multimedia subsystem (IMS) data channel (DC) configuration data as used herein includes configuration data with respect to an IMS DC. In one or more embodiments, as used herein, an IMS DC establishment decision comprises a decision whether to establish an IMS DC (e.g., whether a UE shall establish an IMS DC).

In some embodiments, (i) the IMS DC establishment decision indicates not to open the IMS DC, and (ii) the action includes preventing the UE from establishing the IMS DC. In some embodiments, (i) the IMS DC establishment decision indicates not to open the IMS DC when the UE determines the UE is roaming, and (ii) the method further includes, determining the UE is roaming, where, in response to the determining, the action includes preventing the UE from establishing the IMS DC if the UE is roaming. In some embodiments, (i) the IMS DC establishment decision indicates the UE is authorized to open an IMS DC when a multimedia telephony service (MMTel) session associated with the UE is established, and (ii) the method further includes determining an MMTel session associated with the UE is established, where, in response to the determining, the action includes causing the UE to establish the IMS DC in parallel to establishment of the MMTel session. In some embodiments, (i) the IMS DC establishment decision indicates the UE is authorized to open an IMS DC when a multimedia telephony service (MMTel) session associated with the UE is established and a network associated with the UE has indicated IMS DC support during the IMS registration procedure, and (ii) the method further includes determining the network associated with the UE has indicated IMS DC support during the IMS registration procedure associated with the UE, where, further in response to the determining that the UE has indicated IMS DC support during the IMS registration procedure, the action includes causing the UE to establish the IMS DC in parallel to establishment of the MMTel session. In some embodiments, (i) the IMS DC establishment decision indicates to open the IMS DC when the UE is registered in a home public land mobile network (HPLMN), and (ii) the method further includes determining the UE is registered in the HPLMN, where, in response to the determining, the action includes causing the UE to establish the IMS DC if it is registered in the HPLMN.

In some embodiments, (i) the IMS DC establishment decision indicates to open the IMS DC only once during an IMS registration lifetime or during a MMTel session lifetime, and (ii) the method further includes determining the UE has not established an IMS DC during an IMS registration lifetime or during a MMTel session lifetime associated with the UE, where, in response to the determining, the action includes causing the UE to establish the IMS DC. In some embodiments, (i) the IMS DC establishment decision indicates to open the IMS DC when the UE is registered in one of a plurality of allowed visited public land mobile networks (VPLMNs), and (ii) the method further includes determining the UE is registered in one of the plurality of allowed VPLMNs, where, in response to the determining, the action includes causing the UE to establish the IMS DC. In some embodiments, the method further includes determining a uniform resource locator (URL) address from which one or more available DC applications for the UE are downloadable, where performing the action includes providing the URL address to the UE.

In some embodiments, (i) the IMS DC establishment decision indicates to open the IMS DC when the UE determines the UE is located within at least one predetermined location, and (ii) the method further includes determining a location of the UE and, based at least in part on the location of the UE, determining the UE is located within the at least one predetermined location, where, in response to the determining, the action includes causing the UE to establish the IMS DC. In some embodiments, (i) the IMS DC establishment decision indicates to open the IMS DC in association with a predetermined time interval, (ii) the method further includes determining a time variable for the UE corresponds to the predetermined time interval, where, in response to the determining, the action includes causing the UE to establish the IMS DC. In some embodiments, (i) the IMS DC establishment decision indicates to open the IMS DC in response to one or more statuses or conditions being present in or associated with the UE, and (ii) the method further includes determining the one or more statuses or conditions are present in or associated with the UE, where, in response to the determining, the action includes causing the UE to establish the IMS DC. In some embodiments, the one or more statuses or conditions include a battery state of the UE.

As further described below, in some embodiments, one or more operations of the above-described methods are performed by an apparatus including at least one processor and at least one memory storing instructions that, when executed by the at least one processor, cause the apparatus to perform the one or more operations. For example, an apparatus may include at least one processor and at least one memory storing instructions that, when executed by the at least one processor, cause the apparatus to (i) obtain a data object indicative of internet protocol multimedia subsystem (IMS) data channel (DC) configuration data, the IMS DC configuration data comprising information regarding whether a user equipment (UE) is allowed to establish an IMS data channel, (ii) generate an IMS DC establishment decision based at least in part on the data object, (iii) perform an action based at least in part on the IMS DC establishment decision. In the same example, the apparatus may also perform other operations and/or embody additional aspects of the above-described methods. In some embodiments, the apparatus configured to generate the IMS DC establishment decision and/or perform the action includes a device management server, where the device management server is communicating with a memory or a computing device configured to store the data object indicative of the IMS DC configuration data. In some embodiments the apparatus configured to generate the IMS DC establishment decision and/or perform the action obtains the data object indicative of the IMS DC configuration data from a device management server, where the device management server is communicating with a memory or a computing device configured to store the data object indicative of the IMS DC configuration data. In some embodiments, the device management server is configured to maintain a plurality of data objects, where (i) each of the plurality of data objects is indicative of IMS DC configuration data for one of a plurality of UEs, and (ii) the IMS DC configuration data for each of the plurality of UEs may be the same or different IMS DC configuration data.

In various embodiments, as further described below, provided herein is a computer program product including at least one non-transitory computer-readable storage medium having computer-executable program code instructions stored therein, the computer-executable program code instructions including program code instructions configured for performing one or more operations and/or embody additional aspects of the above-described methods. For example, a computer program product may include at least one non-transitory computer-readable storage medium having computer-executable program code instructions stored therein, the computer-executable program code instructions including program code instructions configured to (i) obtain a data object indicative of internet protocol multimedia subsystem (IMS) data channel (DC) configuration data, the IMS DC configuration data comprising information regarding whether a user equipment (UE) is allowed to establish an IMS data channel, (ii) generate an IMS DC establishment decision based at least in part on the data object, and (iii) perform an action based at least in part on the IMS DC establishment decision. In the same example, the program code instructions may also be configured to perform additional operations and/or embody additional aspects of the above-described methods.

In various embodiments, as further described below, one or more operations of the above-described methods are performed by an apparatus having means for performing the one or more operations. For example, an apparatus may include (i) means for obtaining a data object indicative of internet protocol multimedia subsystem (IMS) data channel (DC) configuration data, the IMS DC configuration data comprising information regarding whether a user equipment (UE) is allowed to establish an IMS data channel, (ii) means for generating an IMS DC establishment decision based at least in part on the data object, and (iii) means for performing an action based at least in part on the IMS DC establishment decision. In the same example, the apparatus may embody additional aspects and/or include additional means for performing additional operations of the above-described methods.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example of a communication system in which an example embodiment of the present disclosure may be implemented;

FIG. 2 illustrates a block diagram of an apparatus that may be configured in accordance with an example embodiment of the present disclosure;

FIG. 3 illustrates a signal diagram for user equipment (UE) configuration of data channel (DC)-related parameters using operations, administration, and maintenance device management (OAM DM) in accordance with an example embodiment of the present disclosure;

FIG. 4 illustrates a diagram for an internet protocol multimedia subsystem (IMS) data channel architecture with a data channel signaling function (DCSF) and a data channel signaling media function (DCMF) in accordance with an example embodiment of the present disclosure; and

FIG. 5 is an example flowchart of a data channel (DC) setup process in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with the described embodiments. Thus, use of any such terms should not be taken to limit the spirit and scope of the embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to signal, non-transitory computer-readable medium and the like. The term ‘non-transitory computer-readable medium’ refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

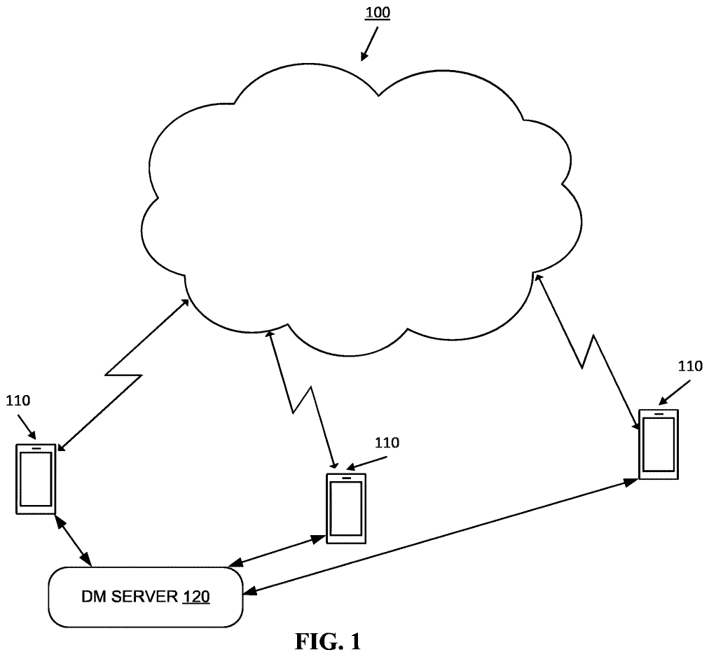

As illustrated in FIG. 1, a communication network 100 is provided in accordance with various embodiments of the present disclosure. In some embodiments, the communication network 100 is in communication with a plurality of user equipment (UE) 110 (e.g., also referred to as a device management (DM) client). By way of example, the network 100 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunications system (UMTS) radio access network (UTRAN, E-UTRAN or NG-RAN), wireless local area network (WLAN or WiFi), worldwide interoperability for microwave access (WiMAX), Bluetooth®, personal communications services (PCS), ZigBee®, wideband code division multiple access (WCDMA), systems via ultra-wideband (UWB) technology, sensor networks, mobile ad-hoc networks (MANETs) and Internet Protocol multimedia subsystems (IMS) or any combination thereof.

The UE 110 may be any type of user terminal, terminal device, etc. to which resources on the air interface are allocated and assigned. For example, the UE may be a portable computing device such as a wireless mobile communication device including, but not limited to, the following types of devices: a mobile station (mobile phone), smartphone, personal digital assistant (PDA), handset, device via a wireless modem (alarm or measurement device, etc.), laptop and/or touch screen computer, tablet, game console, notebook, and multimedia device. The user equipment may also be called a subscriber unit, mobile station, remote terminal, access terminal, user terminal or user equipment (UE) just to mention but a few names or apparatuses.

The network 100 may include a plurality of network devices. In some embodiments, the communication network 100 communicates with one or more device management (DM) servers 120. In some embodiments, the DM server 120 communicates with the UE 110 to perform, in whole or part, one or more functions, operations, or techniques of the present method, apparatus, or computer program product. In various embodiments, the DM server 120 maintains a data object indicative of internet protocol multimedia subsystem (IMS) data channel (DC) configuration data regarding whether a UE 110 is allowed to establish an IMS data channel. In some embodiments, the DM server 120 maintains multiple data objects indicative of different IMS DC configuration data associated with different UEs 110. For example, for at least one UE 110, the DM server 120 maintains a first data object indicative of first IMS DC configuration data regarding whether the at least one UE 110 is allowed to establish an IMS data channel. As another example, for one or more secondary UEs 110, the DM server 120 maintains a second data object indicative of second IMS DC configuration data regarding whether the secondary UE 110(s) is (are) allowed to establish an IMS data channel. In some embodiments the DM server 120 transmits, to one or more UEs 110, a data object indicative of IMS DC configuration data regarding whether the UE(s) 110 is (are) allowed to establish an IMS data channel, which may cause the UE(s) 110 to perform one or operations, functions, and/or aspects of the method, computer program product, and/or or apparatus described herein.

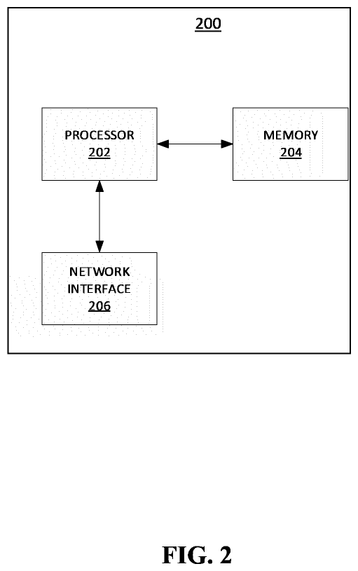

FIG. 2 shows an example apparatus 200 according to one embodiment. The apparatus 200 may be an embodiment of a network device or may be embodied by or otherwise associated with a network device, such as the DM server 120. For example, the apparatus may be embodied by or otherwise associated with the application function (AF), the multicast and broadcast session management function (MB-SMF), and/or the multicast and broadcast user plane function (MB-UPF). Alternatively, or additionally, in some embodiments, the apparatus 200 is an embodiment of a user equipment 110.

Regardless of the device that embodies the apparatus 200, the apparatus may include processor 202, memory 204, and network interface 206. The apparatus 200 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a non-transitory computer-readable storage medium). The memory 204 may be configured to store information, data, content, applications, instructions, or the like for enabling the apparatus to carry out various functions in accordance with an example embodiment disclosed herein.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 202 may be configured to execute instructions stored in the memory 204 and/or circuitry otherwise accessible to the processor 202. In some embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may optionally include input/output circuitry that may, in turn, be in communication with processor 202 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The network interface 206 may be any means such as a device or circuitry embodied in either hardware or a combination of hardware and software that is configured to receive and/or transmit data from/to a network and/or any other device, circuitry, or module in communication with the apparatus 200. In this regard, the network interface 206 may include, for example, a network interface for enabling communications with a wired or wireless communication network, such as the application function (AF), multicast and broadcast service function (MBSF), multicast and broadcast user plane function (MB-UPF), and/or multicast and broadcast session management function (MB-SMF). For example, the network interface 206 may include one or more network interface cards, antennae, buses, switches, routers, modems, and supporting hardware and/or software, or any other device suitable for enabling communications via a network. Additionally, or alternatively, the network interface 206 may include the circuitry for interacting with the antenna/antennae to cause transmission of signals via the antenna/antennae or to handle receipt of signals received via the antenna/antennae.

In some embodiments, the apparatus 200 includes means, such as the processor 202, the memory 204, the network interface 206, or the like, for making various determinations respective to the UE 110. In some embodiments, the apparatus 200 includes means, such as a counter, for determining, how many, if any, DC channels have been established by the UE 110 during an IMS registration lifetime or during an IMS MMTel session lifetime. In some embodiments, the apparatus 200 includes means for determining whether the UE is registered in the HPLMN. In some embodiments, the apparatus 200 includes means for determining whether a network associated with the UE has indicated IMS DC support during an IMS registration procedure associated with the UE. In some embodiments, the apparatus 200 includes means for determining an MMTel session associated with the UE has been, is being, or will be established. In some embodiments, the apparatus 200 includes means for determining whether the UE is roaming. In some embodiments, the apparatus 200 includes means for determining a location of the UE. In some embodiments, the apparatus 200 includes means for determining whether the UE is located within at least one predetermined location based at least in part on a location of the UE (e.g., or a predicted or scheduled location of the UE). In some embodiments, the apparatus 200 includes means for determining a time variable for the UE, such as a current time, an elapsed time following registration or deregistration of the UE with a network (e.g., VPLMN, HPLMN, etc. ,), and potentially other time variables. In some embodiments, the apparatus 200 includes means for determining whether the time variable(s) for the UE correspond to a predetermined time interval, or other time threshold(s). In some embodiments, the apparatus 200 includes means for determining one or more statuses or conditions present in or associated with the UE. Non-limiting examples of the statuses or conditions include battery state of the UE (e.g., current battery level, maximum battery level, battery consumption rate, battery categorization, such as high, medium, or low, and potentially other battery parameters), one or more UE settings, one or more UE configurations, and UE active time. In some embodiments, the apparatus 200 includes means for determining whether the status(es) or condition(s) associated with the UE meet one or more predetermined thresholds or other criteria.

In some embodiments, the apparatus 200 includes means for determining one or more indications present in or otherwise dictated by IMS DC configuration data associated with the UE, such as whether the IMS DC configuration data indicates (i) not to open an IMS DC, (ii) not to open an IMS DC when the UE determines the UE is roaming, (iii) the UE is authorized to open an IMS DC when an MMTel session associated with the UE is established, (iv) the UE is authorized to open an IMS DC when the network 100 has indicated IMS DC support during the IMS registration procedure for the UE, (v) the UE is authorized to open an IMS DC during when registered in the HPLMN, (vi) the UE is authorized to open an IMS DC only once per IMS registration or only once during a MMTel session, (vii) the UE is authorized to open an IMS DC for a particular list of visited public land mobile networks (VPLMNs) (e.g., when the UE determines the UE is roaming), (viii) the UE is authorized to open an IMS DC when the UE determines the UE is located within at least one predetermined location, (ix) the UE is authorized to open an IMS DC in association with a predetermined time interval, and (x) the UE is authorized to open an IMS DC in response to one or more statuses or conditions being present in or associated with the UE.

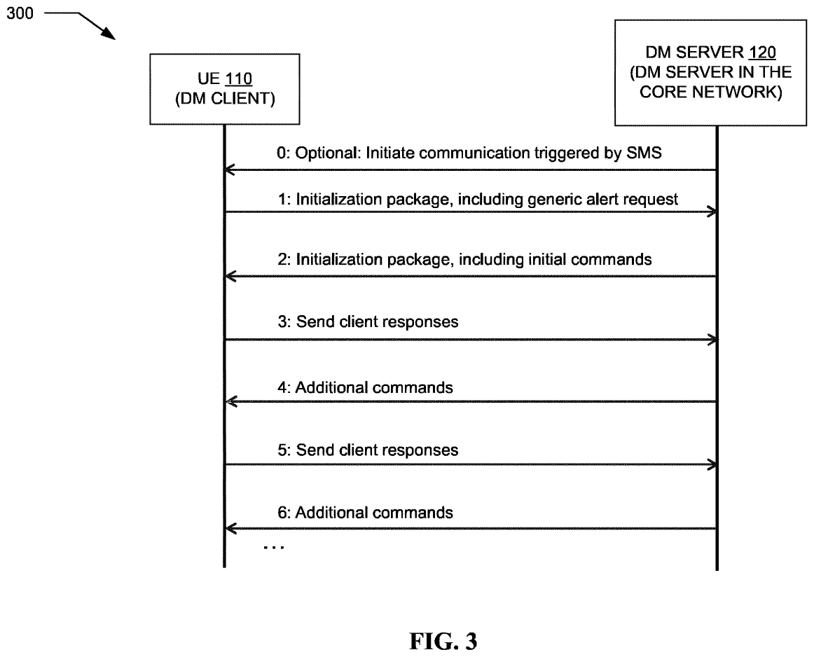

FIG. 3 illustrates a signal diagram 300 for user equipment (UE) configuration of data channel (DC)-related parameters using operations, administration, and maintenance device management (OAM DM) in accordance with an example embodiment of the present disclosure. In the preceding description of the signal diagram 300, one or more of the referenced blocks may correspond to signals transmitted from a UE 110 to a DM server 120, or vice versa. In some embodiments, at an optional initial block (0), the DM server 120 initiates communication with the UE 110 (e.g., a DM client), which may have been triggered by SMS. In some embodiments, at a first block (1), the UE 110 provides an initialization package request to the DM server 120 including a generic alert request. In some embodiments, at a second block (2), the DM server 120 provides a second initialization to the UE 110 including one or more initial commands. In some embodiments, at a third block (3), the UE 110 provides one or more client responses to the DM server 120, which may be responses to the initial command(s). In some embodiments, at a fourth block (4), the DM server 120 provides one or more additional commands to the UE 110, which may be based on the response(s) to the initial command(s). In some embodiments, at a fifth block (5), the UE 110 provides one or more additional responses to the DM server 120, which may be responses to the additional command(s). In some embodiments, at a sixth block (6), the DM server 120 provides one or more additional commands to the UE 120, which may be based on the response(s) to the additional command(s) of block 4. In some embodiments, the intercommunication of commands and responses between the DM server 120 and UE 110 continues at one or more subsequent blocks (not shown).

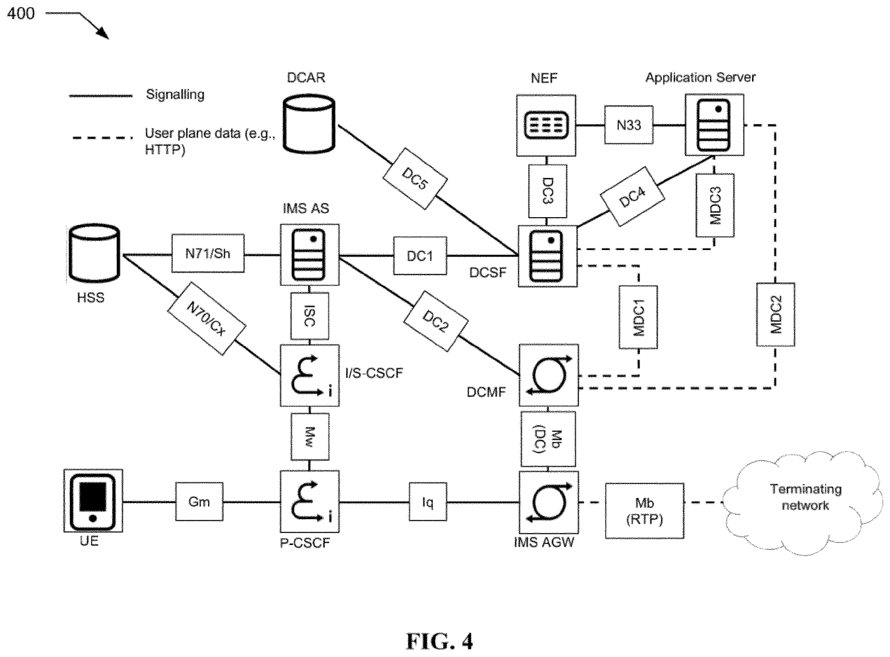

FIG. 4 illustrates a diagram for an internet protocol multimedia subsystem (IMS) data channel architecture 400 with a data channel signaling function (DCSF) and a data channel signaling media function (DCMF) in accordance with an example embodiment of the present disclosure.

IMS is widely deployed to provide voice communication service. In various embodiments, to enable IMS to handle interactive calling in addition to voice communication, 3GPP TS 26.114 and GSMA define the IMS Data Channel (DC) solution. In one or more embodiments, a data channel (DC) is a network channel on top of stream control transmission protocol (SCTP) used for bi-directional peer-to-peer (P2P) or peer-to-application/application-to-peer (P2A/A2P) data transfer. In some embodiments, the IMS DC solution uses session initiation protocol (SIP)/session description protocol (SDP) to perform IMS DC SDP negotiation between UEs and a data channel server (DCS). In some embodiments, as shown in the IMS DC architecture 400, the DCS is de-composed in a DC signaling function (DCSF) and DC media function (DCMF). Alternatively, in some embodiments, an enhanced multimedia resource function (MRF) is used instead of a DCMF.

In some embodiments, based on the SDP negotiation result, the UE establishes a bootstrap data channel with the DCS (DCSF) and use hypertext transfer protocol (HTTP), SCTP, datagram transport layer security (DTLS), and/or user datagram protocol (UDP) protocol to retrieve a menu (e.g., an entry page) with available applications and the application(s) themselves from the DCS. In some embodiments, the application includes a hypertext markup language (HTML) page with embedded JavaScript and potentially other objects like style sheets or images. In some embodiments, the user can select any application from the list. In some embodiments, when the user wants to launch an application, an application data channel is established via SDP negotiation. In some embodiments, once SDP negotiation of the application data channel is completed, the UE exchanges application data within the application data channel (e.g., either with a peer UE or with an application server).

In various embodiments, the IMS DC solutions described herein and shown in the figures significantly improve upon previous to approaches to IMS by enriching an IMS with data channel applications. For example, by using the present IMS data channel solution (e.g., as embodied in the disclosed method, apparatus, or computer program product), numerous and diverse data applications may be implemented and offered to users without the need to pre-install the data applications at the UE, which may also advantageously conserve memory at the UE.

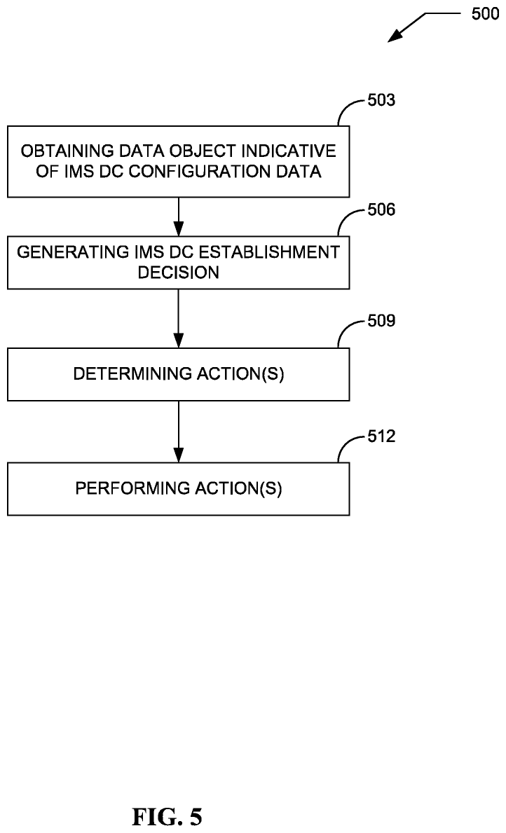

Referring now to FIG. 5, shown is an example flowchart of a data channel (DC) setup process 500, which may be performed by an apparatus, such as the apparatus 200 of FIG. 2 (e.g., which may comprise the DCS 120 shown in FIGS. 1-4 and described herein). In various embodiments, the apparatus performs the process 500 to trigger control performance of DC setup at a user equipment (e.g., such as the user equipment 110 shown in FIGS. 1-4 and described herein). In some embodiments, a UE 110 performs the process 500. For example, a UE 110 may perform the process 500 in response to receiving, from a DM server 120, IMS DC configuration data regarding whether the UE 110 is allowed to establish an IMS data channel.

In some embodiments, at block 503, the apparatus performing the process 500 includes means, such as the processor 202, the memory 204, the network interface 206, or the like, for obtaining a data object indicative of internet protocol multimedia subsystem (IMS) data channel (DC) configuration data, the IMS DC configuration data comprising information regarding whether a user equipment (UE) is allowed to establish an IMS data channel. In some embodiments, the apparatus receives the data object from an operations, administration, and maintenance management device. In some embodiments, the apparatus generates the data object based at least in part on universal integrated circuit card (UICC) configuration data (e.g., with which the UE is associated). In some embodiments, the apparatus, obtains the data object via non-access stratum (NAS) control plane signaling. In some embodiments, the apparatus obtains the data object via a short messaging service (SMS) service. In some embodiments, the apparatus generates the data object based at least in part on one or more user equipment route selection policy (URSP) rules.

In some embodiments, at block 506, the apparatus performing the process 500 includes means, such as the processor 202, the memory 204, the network interface 206, or the like, for generating an IMS DC establishment decision. In some embodiments, the apparatus generates the IMS DC establishment decision based at least in part on the data object. In some embodiments, the IMS DC establishment decision indicates not to open the IMS DC. In some embodiments, the IMS DC establishment decision indicates not to open the IMS DC when the UE determines the UE is roaming. In some embodiments, the IMS DC establishment decision indicates the UE is authorized to open an IMS DC when a multimedia telephony service (MMTel) session associated with the UE is established. In some embodiments, the IMS DC establishment decision indicates the UE is authorized to open an IMS DC when a multimedia telephony service (MMTel) session associated with the UE is established, and a network associated with the UE has indicated IMS DC support during an IMS registration procedure. In some embodiments, the IMS DC establishment decision indicates to open the IMS DC when the UE is registered in a home public land mobile network (HPLMN). In some embodiments, the IMS DC establishment decision indicates to open the IMS DC only once during an IMS registration lifetime or during a MMTel session lifetime. In some embodiments, the IMS DC establishment decision indicates to open the IMS DC when the UE is registered in one of a plurality of allowed visited public land mobile networks (VPLMNs). In some embodiments, the IMS DC establishment decision indicates to open the IMS DC when the UE determines the UE is located within at least one predetermined location. In some embodiments, the IMS DC establishment decision indicates to open the IMS DC in association with a predetermined time interval. In some embodiments, the IMS DC establishment decision indicates to open the IMS DC in response to one or more statuses or conditions being present in or associated with the UE.

In some embodiments, at block 509, the apparatus performing the process 500 includes means, such as the processor 202, the memory 204, the network interface 206, or the like, for performing an action. In some embodiments, the apparatus determines the action based at least in part on the IMS DC establishment decision. In some embodiments, in response to the IMS DC establishment decision indicating not to open the IMS DC, the apparatus determines an action including preventing the UE from establishing the IMS DC. In some embodiments, in response to the IMS DC establishment decision indicating not to open an IMS DC when the UE determines the UE is roaming, the apparatus determines an action including (i) determining the UE is roaming, and (ii) in response to the determining, preventing the UE from establishing the IMS DC. In some embodiments, in response to the IMS DC establishment decision indicating the UE is authorized to open an IMS DC when a multimedia telephony service (MMTel) session associated with the UE is established, the apparatus determines an action including (i) determining an MMTel session associated with the UE is established, and (ii) in response to the determining, causing the UE to establish the IMS DC in parallel to establishment of the MMTel session. Additionally, in some embodiments, the apparatus determines an action including (i) determining a uniform resource locator (URL) address from which one or more available DC applications for the UE are downloadable, and (ii) providing the URL address to the UE.

In some embodiments, in response to the IMS DC establishment decision indicating the UE is authorized to open an IMS DC when a multimedia telephony service (MMTel) session associated with the UE is established and a network associated with the UE has indicated IMS DC support during an IMS registration procedure, the apparatus determines an action including (i) determining the network associated with the UE has indicated IMS DC support during the IMS registration procedure associated with the UE, and (ii) further in response to the determining that the UE has indicated IMS DC support during the IMS registration procedure, causing the UE to establish the IMS DC in parallel to establishment of the MMTel session. In some embodiments, in response to the IMS DC establishment decision indicating to open an IMS DC when the UE is registered in a home public land mobile network (HPLMN), the apparatus determines an action including (i) determining the UE is registered in the HPLMN, and (ii) in response to the determining, the causing the UE to establish the IMS DC. In some embodiments, in response to the IMS DC establishment decision indicating to open an IMS DC only once during an IMS registration lifetime or once during a MMTel session lifetime, the apparatus determines an action including (i) determining the UE has not established an IMS DC during an IMS registration lifetime or during a MMTel session lifetime associated with the UE (e.g., potentially by means of a counter mechanism), and (ii) in response to the determining, causing the UE to establish the IMS DC. In some embodiments, in response to the IMS DC establishment decision indicating to open an IMS DC when the UE is registered in one of a plurality of allowed visited public land mobile networks (VPLMNs), the apparatus determines a response decision including (i) determining the UE is registered in one of the plurality of allowed VPLMNs, and (ii) in response to the determining, causing the UE to establish the IMS DC.

In some embodiments, in response to the IMS DC establishment decision indicating to open an IMS DC when the UE determines the UE is located within at least one predetermined location, the apparatus determines a response decision including (i) determining a location of the UE, (ii) determining the UE is located within at least one predetermined location based at least in part on the location of the UE, and (iii) in response to the determining, causing the UE to establish the IMS DC. In some embodiments, in response to the IMS DC establishment decision indicating to open an IMS DC in association with a predetermined time interval, the apparatus determines a response decision including (i) determining a time variable for the UE corresponds to a predetermined time interval, and (ii) in response to the determining, causing the UE to establish the IMS DC. In some embodiments, in response to the IMS DC establishment decision indicating to open an IMS DC in response to one or more statuses or conditions being present in or associated with the UE (e.g., such as a particular battery state of the UE), the apparatus determines a response decision including (i) determining the one or more statuses or conditions are present in or associated with the UE, and (ii) in response to the determining, causing the UE to establish the IMS DC.

In some embodiments, at block 512, the apparatus performing the process 500 includes means, such as the processor 202, the memory 204, the network interface 206, or the like, for performing one or more actions. In some embodiments, the apparatus prevents the UE from establishing the IMS DC. In some embodiments, the apparatus (i) determines the UE is roaming, and (ii) in response to the determining, prevents the UE from establishing the IMS DC. In some embodiments, the apparatus (i) determines an MMTel session associated with the UE is established, and (ii) in response to the determining, causes the UE to establish the IMS DC in parallel to establishment of the MMTel session. In some embodiments, the apparatus (i) determines the network associated with the UE has indicated IMS DC support during an IMS registration procedure associated with the UE, and (ii) further in response to the determining that the UE has indicated IMS DC support during the IMS registration procedure, causes the UE to establish the IMS DC in parallel to establishment of the MMTel session. In some embodiments, the apparatus determines the UE is registered in the HPLMN, and in response to the determining, causes the UE to establish the IMS DC. In some embodiments, the apparatus (i) determines the UE has not established an IMS DC during an IMS registration lifetime or during a MMTel session lifetime associated with the UE, and (ii) in response to the determining, the causes the UE to establish the IMS DC. In some embodiments, the apparatus (i) determines the UE is registered in one of the plurality of allowed VPLMNs, and (ii) in response to the determining, causes the UE to establish the IMS DC. Additionally, in some embodiments, the apparatus (i) determines a uniform resource locator (URL) address from which one or more available DC applications for the UE are downloadable, and (ii) provides the URL address to the UE.

In some embodiments, the apparatus (i) determines a location of the UE, (ii) determines the UE is located within at least one predetermined location, and (iii) in response to the determining, causes the UE to establish the IMS DC. In some embodiments, the apparatus (i) determines a time variable for the UE corresponds to a predetermined time interval, and (ii) in response to the determining, causes the UE to establish the IMS DC. In some embodiments, the apparatus determines (i) one or more statuses or conditions are present in or associated with the UE, and (ii) causes the UE to establish the IMS DC.

In various embodiments, the method, apparatus and computer program product of the present disclosure are provided for triggering and performing, or preventing, data channel setup in user equipment. The method, apparatus, and computer program product provided improved solutions for triggering data channel setup in UE by using operations, administration, and maintenance device management techniques. In various embodiments, the method, apparatus, and computer program product improve telecommunication services by providing means for configuring and managing a UE regarding when to setup a data channel (DC), which may overcome technical challenges and/or consequences of previous approaches where DC setup is left purely to UE implementation. For example, the present method, apparatus, and computer program product may optimize and reduce resource usage by reducing repetitious and unpredictable establishment and use of DCs.

It will be understood that each block of the flowcharts and combination of blocks in the flowcharts show in the figures and described herein may be implemented by various means, such as hardware, firmware, processor, circuitry, and/or communication devices associated with execution of software including one or more program instructions. For example, one or more of the procedures or operations described above may be embodied by computer program instructions. In this regard, the computer program instructions which embody the procedures or operations described above may be stored by a memory 204 of an apparatus (e.g., user equipment (UE)) employing a disclosed embodiment and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1. An apparatus comprising:
at least one processor; and
at least one memory storing instructions which, when executed by the at least one processor, cause the apparatus to perform operations, the operations comprising:
obtaining a data object indicative of internet protocol multimedia subsystem (IMS) data channel (DC) configuration data, the IMS DC configuration data comprising information regarding whether a user equipment (UE) is allowed to establish an IMS data channel;
generating an IMS DC establishment decision based at least in part on the data object; and
performing an action based at least in part on the IMS DC establishment decision.

2. The apparatus of claim 1, wherein the obtaining the data object comprises:
receiving the data object from an operations, administration, and maintenance management device.

3. The apparatus of claim 1, wherein the obtaining the data object comprises:
generating the data object based at least in part on universal integrated circuit card (UICC) configuration data.

4. The apparatus of claim 1, wherein the obtaining the data object comprises:
obtaining the data object via non-access stratum (NAS) control plane signaling.

5. The apparatus of claim 1, wherein the obtaining the data object comprises:
obtaining the data object via a short messaging service (SMS) service.

6. The apparatus of claim 1, wherein the obtaining the data object comprises:
generating the data object based at least in part on one or more user equipment route selection policy (URSP) rules.

7. The apparatus of claim 1,
wherein the IMS DC establishment decision indicates not to open the IMS DC; and
wherein the action comprises preventing the UE from establishing the IMS DC.

8. The apparatus of claim 1,
wherein the IMS DC establishment decision indicates not to open the IMS DC when the UE determines the UE is roaming; and
wherein the operations further comprise:
determining the UE is roaming, wherein, in response to the determining, the action comprises preventing the UE from establishing the IMS DC.

9. The apparatus of claim 1,
wherein the IMS DC establishment decision indicates the UE is authorized to open the IMS DC when a multimedia telephony service (MMTel) session associated with the UE is established; and
wherein the operations further comprise:
determining an MMTel session associated with the UE is established, wherein, in response to the determining, the action comprises causing the UE to establish the IMS DC in parallel to establishment of the MMTel session.

10. The apparatus of claim 9,
wherein the IMS DC establishment decision indicates the UE is authorized to open the IMS DC when a multimedia telephony service (MMTel) session associated with the UE is established and a network associated with the UE has indicated IMS DC support during an IMS registration procedure; and
wherein the operations further comprise:
determining the network associated with the UE has indicated IMS DC support during the IMS registration procedure associated with the UE, wherein, further in response to the determining that the UE has indicated IMS DC support during the IMS registration procedure, the action comprises causing the UE to establish the IMS DC in parallel to establishment of the MMTel session.

11. The apparatus of claim 1,
wherein the IMS DC establishment decision indicates to open the IMS DC when the UE is registered in a home public land mobile network (HPLMN); and
wherein the operations further comprise:
determining the UE is registered in the HPLMN, wherein, in response to the determining, the action comprises causing the UE to establish the IMS DC.

12. The apparatus of claim 1,
wherein the IMS DC establishment decision indicates to open the IMS DC only once during an IMS registration lifetime or during an IMS MMTel session lifetime; and
wherein the operations further comprise:
determining the UE has not established an IMS DC during an IMS registration lifetime or during an IMS MMTel session lifetime associated with the UE, wherein, in response to the determining, the action comprises causing the UE to establish the IMS DC.

13. The apparatus of claim 1,
wherein the IMS DC establishment decision indicates to open the IMS DC when the UE is registered in one of a plurality of allowed visited public land mobile networks (VPLMNs); and
wherein the operations further comprise:
determining the UE is registered in one of the plurality of allowed VPLMNs, wherein, in response to the determining, the action comprises causing the UE to establish the IMS DC.

14. The apparatus of claim 1,
wherein the IMS DC establishment decision indicates to open the IMS DC when the UE determines the UE is located within at least one predetermined location; and
wherein the operations further comprise:
determining a location of the UE; and
based at least in part on the location of the UE, determining the UE is located within the at least one predetermined location, wherein, in response to the determining, the action comprises causing the UE to establish the IMS DC.

15. The apparatus of claim 1,
wherein the IMS DC establishment decision indicates to open the IMS DC in association with a predetermined time interval; and
wherein the operations further comprise:
determining a time variable for the UE corresponds to the predetermined time interval, wherein, in response to the determining, the action comprises causing the UE to establish the IMS DC.

16. The apparatus of claim 1,
wherein the IMS DC establishment decision indicates to open the IMS DC in response to one or more statuses or conditions being present in or associated with the UE; and
wherein the operations further comprise:
determining the one or more statuses or conditions are present in or associated with the UE, wherein, in response to the determining, the action comprises causing the UE to establish the IMS DC.

17. The apparatus of claim 16, wherein the one or more statuses or conditions comprise a battery state of the UE.

18. The apparatus of claim 1, the opertions further comprising:
determining a uniform resource locator (URL) address from which one or more available DC applications and associated DC application parameters for the UE are downloadable, wherein the performing the action comprises providing the URL address to the UE.

19. The apparatus of claim 1, wherein the obtaining the data object comprises:
obtaining the data object from a device management server, wherein the device management server is configured to communicate with a memory or a computing device configured to store the data object.

20. (canceled)

21. A non-transitory computer-readable medium:
storing instructions which, when executed by the at least one processor of a data channel server, cause the data channel server to perform a operations, the operations comprising:
obtaining a data object indicative of internet protocol multimedia subsystem (IMS) data channel (DC) configuration data, the IMS DC configuration data comprising information regarding whether a user equipment (UE) is allowed to establish an IMS data channel;
generating an IMS DC establishment decision based at least in part on the data object; and
performing an action based at least in part on the IMS DC establishment decision.

22.-24. (canceled)
